(19) United States
(12) Patent Application Publication
(10) Pub. No.: US 2020/0112009 A1
(43) Pub. Date: Apr. 9, 2020

(54) ELECTROCHEMICAL CELL ENCLOSURE INCLUDING A FLAME ARRESTOR

(71) Applicant: Sargent Manufacturing Company, New Haven, CT (US)

(72) Inventors: Daniel W. Riley, Meriden, CT (US); Eric Palmieri, Rocky Hill, CT (US)

(73) Assignee: Sargent Manufacturing Company, New Haven, CT (US)

(21) Appl. No.: 16/517,848

(22) Filed: Jul. 22, 2019

Related U.S. Application Data
(60) Provisional application No. 62/741,035, filed on Oct. 4, 2018.

(51) Int. Cl. H01M 2/12; H01M 2/02; H01M 2/10

(52) U.S. Cl. CPC H01M 2/127; H01M 2/1258; H01M 2200/20; H01M 2/02; H01M 2/1016; H01M 2/1205

(57) ABSTRACT

Electrochemical cell enclosures and related methods are disclosed. In one embodiment, gas vented from one or more electrochemical cells flows through a flame arrestor, and in some instances a filter, to reduce a temperature of the vented gas to a desired temperature prior to the gas exiting the enclosure through an associated outlet. In certain embodiments, this reduced temperature may be less than an auto-ignition temperature of the gas.

### FIELD

Disclosed embodiments are related to electrochemical cell enclosures including flame arrestors.

### BACKGROUND

Electrochemical cells are oftentimes assembled into module and/or pack assemblies within an external electrochemical cell housing. The enclosure may be used to provide structural rigidity and protection to the one or more electrochemical cells contained therein and/or to provide a desired form factor for an overall battery unit.

### SUMMARY

In one embodiment, an electrochemical cell enclosure may include a housing, at least one electrochemical cell disposed in the housing, at least one outlet formed in the housing, and a flame arrestor disposed between the at least one electrochemical cell and the at least one outlet. The flame arrestor may be configured to reduce a temperature of gas emitted from the at least one electrochemical cell as the gas flows through the flame arrestor to the at least one outlet.

In another embodiment, a method of mitigating a venting and/or thermal runaway event of an electrochemical cell may include: flowing gas emitted from the electrochemical cell through a flame arrestor to reduce a temperature of the gas; and flowing the gas at the reduced temperature through an outlet of a housing that the electrochemical cell is located in.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic of one embodiment of an electrochemical cell enclosure; and

FIG. 2 is the electrochemical cell enclosure of FIG. 1 during a thermal runaway, or venting, event.

### DETAILED DESCRIPTION

Electrochemical cells, including, for example, lithium ion based electrochemical cells, can emit various high temperatures volatile gases, sparks, and flames during events, such as thermal runaway events, which may be initiated by a variety of causes including, but not limited to, excessive temperatures, structural damage, dendritic growth, and/or overcharging events to name a few. Additionally, due to the use of electroactive materials that include oxygen, the decomposing electroactive materials may release oxygen during these events as well. Therefore, even within sealed compartments, the released gas may support combustion under these conditions, and if not controlled may result in the release of high temperature gas and/or flames from the electrochemical cells onto surrounding components. In applications where multiple assemblies of electrochemical cells are used, the gas and/or flames may cause heating and subsequent thermal runaway of the other electrochemical cells, i.e. thermal runaway propagation, in a system.

In view of the above, the Inventors have recognized that it may be desirable to help mitigate the release of hot gas and/or flames from a system including electrochemical cells through the use of one or more features included in a housing constructed to receive the electrochemical cells. For example, the Inventors have recognized the benefits associated with reducing the temperature of gas prior to the gas exiting from an outlet of an associated housing of an electrochemical cell enclosure. By reducing the gas temperature, the presence of flames may be suppressed and temperatures experienced by components directly in the path of the released gas may also be reduced. Further, in some instances, the temperature of the gas may be reduced to a temperature that is below an auto-ignition temperature of the emitted gas which may further help to suppress the occurrence of flames during a thermal runaway or other event.

In view of the above, in one embodiment, an electrochemical cell enclosure may include a housing and at least one electrochemical cell disposed in the housing. The housing may include at least one outlet formed in the housing to permit the vented gas to exit the enclosure during a venting event. The enclosure may also include a flame arrestor disposed between the at least one electrochemical cell and the at least one outlet. Correspondingly, when gas is emitted from the at least one electrochemical cell, the emitted gas may flow through the flame arrestor which may reduce a temperature of the gas prior to flowing out from the enclosure through the at least one outlet at the reduced temperature. In some embodiments, the enclosure may also include a filter disposed between the at least one electrochemical cell and the outlet to filter particulate materials including, for example, soot from the gas prior to it flowing out from the enclosure through the noted outlet. In some embodiments, the filter may be located downstream from the flame arrestor such that it is disposed between the flame arrestor and the at least one outlet.

Depending on the particular application, a flame arrestor may be made from any porous material with an appropriate thermal conductivity and thermal mass for absorbing a sufficient amount of heat energy from gas vented from one or more associated electrochemical cells to cool the gas to a desired temperature. As noted above, in some embodiments, the temperature the flame arrestor is configured to cool the emitted gas to may be less than an auto-ignition temperature of the emitted gas above which the gas may ignite when exposed to an atmosphere containing oxygen. The specific materials and dimensions used to provide a desired amount of cooling may be selected using considerations such as the specific thermal capacity, the thermal conductivity, and the overall mass or volume of the flame arrestor material as well as the expected specific thermal capacity, the volume or mass of emitted gas, and the temperature of emitted gas from the one or more electrochemical cells. Using these considerations, in some embodiments, a flame arrestor may be constructed using appropriate materials and may be appropriately sized to absorb a sufficient amount of energy to cool a volume of high temperature gas that would be expected to be emitted if a portion, or all, of the electrochemical cells within an enclosure were to undergo a thermal runaway, or other venting, event. Of course, it should be understood that while various design parameters are noted above, any appropriate design parameter for selecting an appropriate flame arrestor construction to provide a desired amount of cooling to gas emitted from one or more electrochemical cells may be used as the disclosure is not limited in this fashion.

Specific types of structures that may be used for a flame arrestor may include, but are not limited to, wools, meshes, filters, woven materials, non-woven materials, open cell foams, and/or other appropriate structures. Additionally, these structures may be made using any appropriate conductive material including, but not limited to conductive metallic materials such as steel, copper, and bronze. Of course, it should be understood that any appropriate porous conductive material capable of permitting gas to flow through the structure, while absorbing heat from the gas, may be used as the current disclosure is not so limited.

As noted above, a flame arrestor may be appropriately constructed to provide a desired temperature decrease for a flow of hot gas through the flame arrestor. For example, in one embodiment, a flame arrestor may be constructed such that a final temperature of gas released from an electrochemical cell may be reduced by a factor that is greater than or equal to 2, 3, 4, 5, or any other appropriate factor relative to a temperature of the gas when initially vented from an electrochemical cell. Correspondingly, a temperature of the released gas may be reduced by a factor that is less than or equal to 5, 4, 3, or any other appropriate factor relative to the temperature of the gas when initially vented. Combinations of the above ranges are contemplated including, for example, a temperature of gas that passes through the flame arrestor towards an outlet of an enclosure housing may be reduced by a factor that is between or equal to about 2 and 5. This may lead to a final temperature of gas exiting an outlet of the enclosure that is less than the auto-ignition temperatures of one or more components of the gas vented from the electrochemical cells. Typical gases that may be vented from electrochemical cells may include, but are not limited to, H₂, CH₄, C₂H₄, C₂H₂, C₃H₆, C₂H₆, C₄H₈, C₃H₈, and C₄H₁₀. In view of these gases and their auto-ignition temperatures, in some embodiments, a flame arrestor may be constructed such that an absolute temperature of the gas after flowing through the flame arrestor prior to exiting an outlet of an enclosure may be less than or equal to 300° C., 200° C., 100° C., or any other appropriate temperature. Of course the currently disclosed systems are not limited to any particular reduction in temperature and/or absolute temperature of gas after passing through a flame arrestor and/or exiting the system. Accordingly, embodiments in which a temperature of a gas is reduced by a factor, and/or has an absolute temperature, that is greater than or less than the ranges noted above are also contemplated as the disclosure is not so limited.

In addition to the above, a filter used in the one or more embodiments disclosed herein may correspond to any porous flame resistant material that includes appropriately sized pores to filter out soot and/or other particulates above a desired size threshold. It should be understood that an appropriate filtration size for a particular battery enclosure may be dependent on the particular electrochemistry and cell construction used as different battery constructions may vent different mixes of gases at different temperatures with different amounts, sizes, and types of particulate matter contained in the flow of gas. Appropriate filter materials may include, but are not limited to, an open porous structure, a woven material, a non-woven material, a porous network formed by packed together particles and/or fibers, and/or any other structure capable of flowing gas through a filter while providing a desired filtration size. Appropriate flame resistant materials the filter may be made from may include, but are not limited to, alumina, flame resistant composite foams, pumice, zeolites, fiber glass, and/or any other appropriate material. A flame resistant material may refer to a material that does not combust under the temperatures and conditions experienced during a thermal runaway event and/or a material that self extinguishes after being exposed to temperatures sufficient to combust the material when exposed to oxygen.

An electrochemical enclosure as disclosed herein may include a housing made from any number of materials and with any number of different shapes and/or internal cavity arrangements. For example, a housing may be made from plastic, metal (e.g. steel, aluminum, etc.), epoxy resins, combinations of the forgoing, and/or any other appropriate material. Additionally, the size and arrangement of the various enclosure walls of the housing may be arranged in any manner to provide a desired exterior size and shape while accommodating one or more electrochemical cells disposed in an interior cavity of the housing. In some embodiments, the one or more electrochemical cells may be oriented, and/or the housing may be constructed with appropriate materials and/or thicknesses, such that the housing is capable of withstanding the temperatures and/or pressures present during a thermal runaway, or other venting, event of the one or more electrochemical cells without rupturing.

As noted above a battery enclosure may include one or more outlets formed in a housing to permit vented gas from one or more electrochemical cells contained therein to exit the housing through the one or more outlets. The one or more outlets may have any appropriate size, shape, and/or arrangement. Further, the overall cross sectional area of the openings parallel to a surface of the enclosure housing they are formed in may be selected in combination with an overall flow resistance of the flow path between the one or more outlets and the one or more electrochemical cells contained within the housing to maintain a pressure within the housing below a desired threshold pressure during a thermal runaway, or other gas venting, event. For example, the flow path from the electrochemical cells to the one or more outlets may pass through the flame arrestor, and in some embodiments a filter, which may increase the overall flow resistance for gas flowing to the outlets. Therefore, the outlet sizes and number of outlets may take into account this flow resistance from the flame arrestor and filter, the enclosure interior volume, as well as the expected volume and flow rate of gas emitted from the one or more electrochemical cells during a thermal runaway, or other venting, event to maintain the pressure within the enclosure below the desired pressure threshold.

In addition to the above, the Inventors have also recognized the benefits associated with reacting one or more components contained in a vented gas with a material contained in an associated flame arrestor and/or filter to remove one or more components of the gas emitted during a thermal runaway, or other venting, event that are either volatile, reactive, and/or toxic prior to releasing the gas from the associated enclosure. Correspondingly, in at least some embodiments, a gas released from one or more electrochemical cells located within an interior chamber of an enclosure of an electrochemical cell housing may flow from the interior chamber through one or more materials the flame arrestor and/or filter are made from and that are reactive with one or more components of the gas. Accordingly, one or more components of the gas may react with the noted material of the flame arrestor and/or filter to at least partially remove the reactive components from the gas. The gas may then exit the system through one or more outlets of the enclosure. It should be understood that depending on the particular component to be removed from the gas, different types of flame arrestor and/or filter materials may be used. For example, in embodiments in which a lithium sulfate chemistry is used, a filter including fiber glass may react with sulfur contained in the high temperature gas to at least partially remove the sulfur from the gas prior to the gas being vented from the system. Of course different materials and/or electrochemistries may be used as the current disclosure is not limited to any particular type of electrochemical cell and/or specific components of a gas to be removed.

It should be understood that the disclosed enclosures including flame arrestors and/or filters to help mitigate a thermal runaway, and/or another gas venting, event are not limited to use with any particular electrochemistry. For example, the disclosed systems may be used with electrochemistries including, but not limited to: lithium ion cells such a lithium sulfate, lithium iron phosphate, lithium cobalt oxide, lithium manganese oxide; alkaline cells; metallic lithium cells; nickel metal hydride cells; lead acid cells; nickel cadmium cells; silver oxide cells; and/or any other appropriate electrochemistry as the disclosure is not limited in this fashion.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

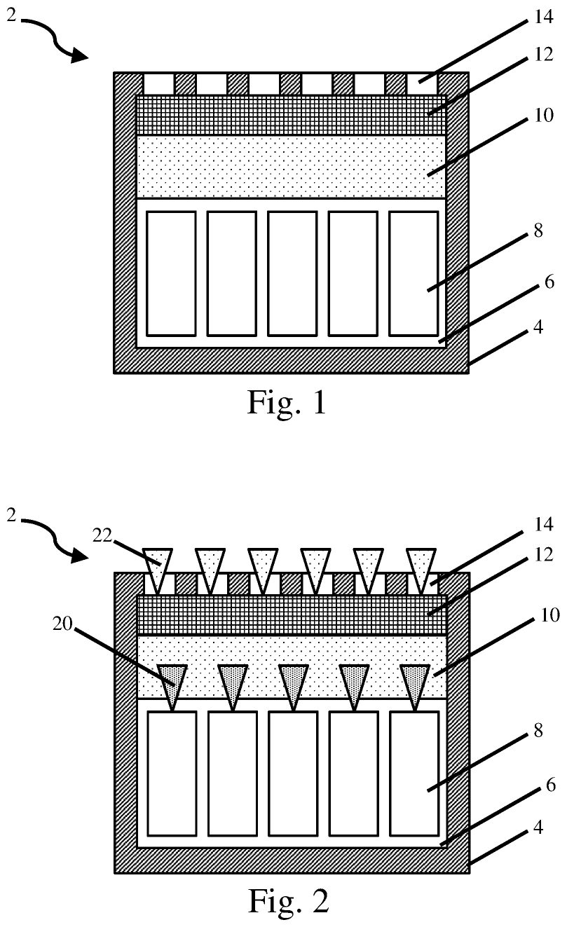

FIG. 1 depicts one embodiment of an electrochemical cell enclosure 2 which may include a housing 4 with an interior chamber 6 formed therein in which one or more electrochemical cells 8 are disposed. A flame arrestor 10 may be disposed within the housing in a position disposed between the one or more electrochemical cells and one or more outlets 14 formed in at least one surface of the housing. For example, the one or more electrochemical cells may be disposed within the interior chamber of the housing adjacent to a first side of the housing, and the one or more vents may be formed on an opposing side of the housing opposite from the electrochemical cells. In some embodiments, the enclosure may also include a filter 12 which may also be disposed between the one or more electrochemical cells and the one or more vents. The filter may be disposed between the flame arrestor and the one or more vents such that the filter may be considered to be downstream from the flame arrestor relative to a flow of gas emitted from the one or more electrochemical cells. However, embodiments in which the filter is upstream from the flame arrestor are also contemplated. In either case, gas vented from the one or more electrochemical cells may flow through the flame arrestor and filter prior to flowing out from the one or more vents as described in more detail below.

FIG. 2 depicts the electrochemical cell enclosure 2 of FIG. 1 during a thermal runaway, or other venting, event. Initially, high temperature gas 20 is vented from the one or more electrochemical cells 8. In some instances, preformed vents in the electrochemical cells, not depicted, may be arranged to direct the vented gas towards the flame arrestor 10. However, embodiments in which the gas is vented in a direction that is not oriented directly towards the flame arrestor are also contemplated. In either case, the high temperature gas may flow through the flame arrestor. As the gas flows through the flame arrestor, a temperature of the gas may be reduced to a temperature that is less than a desired target temperature such as below an auto-ignition temperature of the gas. The cool gas may then flow through a filter 12 which may remove soot and/or other particulate matter from the flow of gas prior to the cooled and filtered gas 22 exiting through one or more outlets 14 formed in a housing 4 of the enclosure.

While the embodiment described above has shown the electrochemical cells, flame arrestor, filter, and outlets formed in the housing in a particular configuration, the current disclosure is not limited to only the depicted arrangement of these components. For example, the outlets may be provided on any one or more surfaces of a housing such that gas emitted from the one or more electrochemical cells passes through the associated flame arrestor, and in certain embodiments an associated filter, prior to exiting the enclosure through the one or more outlets. Thus, the outlets may be positioned on a surface of a housing opposite the electrochemical cells and/or on the sides of the housing as long as the gas flows through a flame arrestor prior to flowing through an outlet of the housing. Additionally, while the filter and flame arrestor have been depicted with the flame arrestor positioned upstream relative to the filter with the flame arrestor disposed between the filter and the one or more electrochemical cells, other arrangements are also contemplated. For instance, embodiments in which the filter is disposed upstream from the flame arrestor such that it is between the flame arrestor and the one or more electrochemical cells are also contemplated. Further, while rectangular structures have been depicted for the flame arrestor and filter, any appropriately shaped and sized materials capable of providing the desired functionality for the flame arrestor and filter may be used as the disclosure is not limited to a particular size and/or shape of these components. Accordingly, it should be understood that the present disclosure should be interpreted generally as disclosing flowing gas vented from one or more electrochemical cells through a flame arrestor, and in some embodiments a filter, to reduce a temperature of the gas prior to exiting an outlet of an enclosure using any appropriate construction and arrangement of the disclosed components to provide this desired functionality.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. An electrochemical cell enclosure comprising:
a housing;
at least one electrochemical cell disposed in the housing;
at least one outlet formed in the housing; and
a flame arrestor disposed between the at least one electrochemical cell and the at least one outlet, wherein the flame arrestor is configured to reduce a temperature of gas emitted from the at least one electrochemical cell as the gas flows through the flame arrestor to the at least one outlet.

2. The electrochemical cell enclosure of claim 1, wherein the flame arrestor is configured to reduce the temperature of the gas to below an auto-ignition temperature of the gas.

3. The electrochemical cell enclosure of claim 1, wherein the flame arrestor comprises a porous conductive material.

4. The electrochemical cell enclosure of claim 1, further comprising a filter disposed between the at least one electrochemical cell and the at least one outlet.

5. The electrochemical cell enclosure of claim 4, wherein the filter is disposed between the flame arrestor and the at least one outlet.

6. The electrochemical cell enclosure of claim 4, wherein the filter is configured to filter soot from the gas.

7. The electrochemical cell enclosure of claim 4, wherein the filter comprises a porous flame resistant material.

8. The electrochemical cell enclosure of claim 4, wherein the filter reacts with one or more components of the gas to at least partially remove the one or more components from the gas prior to the gas exiting the at least one outlet.

9. A method of mitigating a venting and/or thermal runaway event of an electrochemical cell, the method comprising:
flowing gas emitted from the electrochemical cell through a flame arrestor to reduce a temperature of the gas; and
flowing the gas at the reduced temperature through an outlet of a housing that the electrochemical cell is located in.

10. The method of claim 9, further comprising reducing the temperature of the gas to below an auto-ignition temperature of the gas with the flame arrestor.

11. The method of claim 9, wherein flowing the gas through the flame arrestor includes flowing the gas through a porous conductive material.

12. The method of claim 9, further comprising filtering the gas prior to the gas flowing through the at least one outlet.

13. The method of claim 12, wherein the gas is filtered downstream from the flame arrestor.

14. The method of claim 12, wherein the gas is filtered to remove soot from the gas.

15. The method of claim 12, wherein the gas is filtered using a porous flame resistant material.

16. The method of claim 12, further comprising reacting one or more components of the gas with a filter material used to filter the gas to at least partially remove the one or more components from the gas prior to the gas exiting the at least one outlet.
